(19) United States
(12) Patent Application Publication
(10) Pub. No.: US 2020/0203054 A1
(43) Pub. Date: Jun. 25, 2020

(54) POWER SUPPLY PLATFORM SUPPORTING INTEGRATED TRANSFORMER AND DISCONNECT

(71) Applicant: Jamie Austin JELLESED, Keene, ND (US)

(72) Inventor: Jamie Austin JELLESED, Keene, ND (US)

(21) Appl. No.: 16/722,793

(22) Filed: Dec. 20, 2019

Related U.S. Application Data
(60) Provisional application No. 62/784,061, filed on Dec. 21, 2018.

(51) Int. Cl. H01F 27/06; H01F 38/16; H01F 27/40; H01F 27/42; H01F 27/00

(52) U.S. Cl. CPC H01F 27/06; H01F 38/16; H01F 27/002; H01F 27/42; H01F 27/402

(57) ABSTRACT

A power supply platform is provided. It includes a first base, a first transformer mounted above the first base and having an opening in a bottom side of the first transformer, a panel board mounted on the first base, a first disconnect mounted on the panel board, a first wire set extending along a first wire pathway and connecting the first transformer and the first disconnect, and the first wire pathway at least in part extending below the first transformer and entering the first transformer from the opening in the bottom side of the first transformer.

### CROSS REFERENCE TO RELATED APPLICATIONS

The instant Application claims priority to U.S. Provisional Application 62/784,061 entitled POWER SUPPLY PLATFORM SUPPORTING INTEGRATED TRANSFORMER AND DISCONNECT filed Dec. 21, 2018, the contents of which are expressly incorporated by reference herein in its entirety.

### FIELD OF THE INVENTION

Various embodiments described herein relate generally to transformers and disconnects. More specifically, various embodiments herein relate to a transformer and disconnect being mounted on a common frame.

### BACKGROUND

Utility transformers are often needed on various working sites, such as oil drilling. Transformers are connected to emergency switches known in the art as disconnects. The transformer and the disconnects are typically connected by MCHL cables, which are armored control cables with a continuously welded sheath designed for general purpose use in hazardous environments.

Due to the stiffness and overall general lack of flexibility in MCHL cables, the disconnects must be separated from the transformer by a distance of at least 40 feet; installation thus requires that a trench be excavated at least five feet deep between the transformer site and the disconnect site, and the cable be laid and buried in that trench. To support the disconnects, a panel board with legs is provided, for which holes are dug into the ground to accommodate the legs with concrete (similar to a fence post installation). To support the transformer, an appropriately sized area must be excavated and filled with a foundation made of a fiberglass vault and a concrete slab. The transformer often needs to be installed by a crane onto the foundation. The trench runs from the disconnects to the foundation, and the MCHL cables are connected to the disconnects, extend buried along the trench into the transformer foundation and enter the transformer from below.

Installation of an on-site utility transformer per the above methodology requires specialized and expensive equipment, is a labor intensive, and subject to favorable weather conditions. By way of example, cold or rainy conditions may prevent excavation. Cranes are provided by utility power companies to lift the transformers are often not readily available. The MCHL cables with their overall stiffness and high weight at almost 7 lbs per foot and are difficult to move and install, and expensive at about $32-36 per foot. Due to these obstacles, installation of a 1500 KVA utility transformer using this methodology would thus run on the order of $50k, almost half of which is the MCHL cable cost.

### DRAWINGS

Various embodiments in accordance with the present disclosure will be described with reference to the drawings, in which:

FIGS. 1-4 are respectively side, front, top and bottom views of an embodiment of the invention.

FIG. 5 shows a cross section of an I-beam used in the embodiments of FIGS. 1-4.

FIGS. 6-9 are respectively side, front, top and bottom views of another embodiment of the invention.

FIG. 10 shows a stacked cable conduit used in the embodiments of FIGS. 6-9.

FIGS. 11-13 are perspective views of another embodiment of the invention.

FIGS. 14-16 are perspective views of another embodiment of the invention.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Several definitions that apply throughout this disclosure will now be presented. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized means “including, but not necessarily limited to”; it specifically indicates open-ended inclusion or membership in the so-described combination, group, series and the like. The term “a” means “one or more” unless the context clearly indicates a single element. The term “about” when used in connection with a numerical value means a variation consistent with the range of error in equipment used to measure the values, for which ±5% may be expected. “First,” “second,” etc., re labels to distinguish components or blocks of otherwise similar names, but does not imply any sequence or numerical limitation.

As used herein, the term “front”, “rear”, “side”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

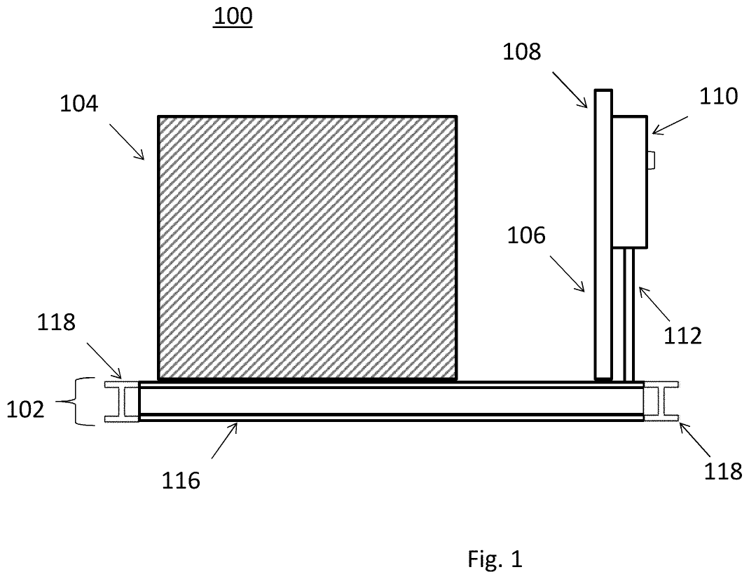

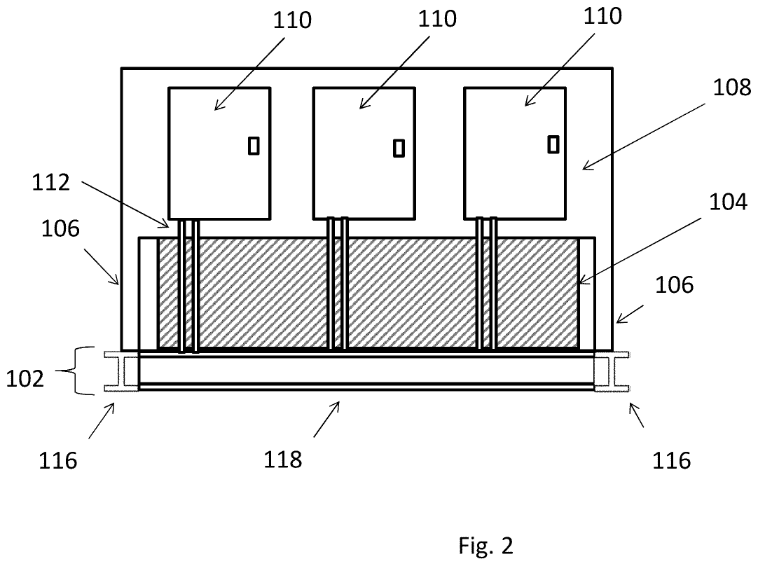

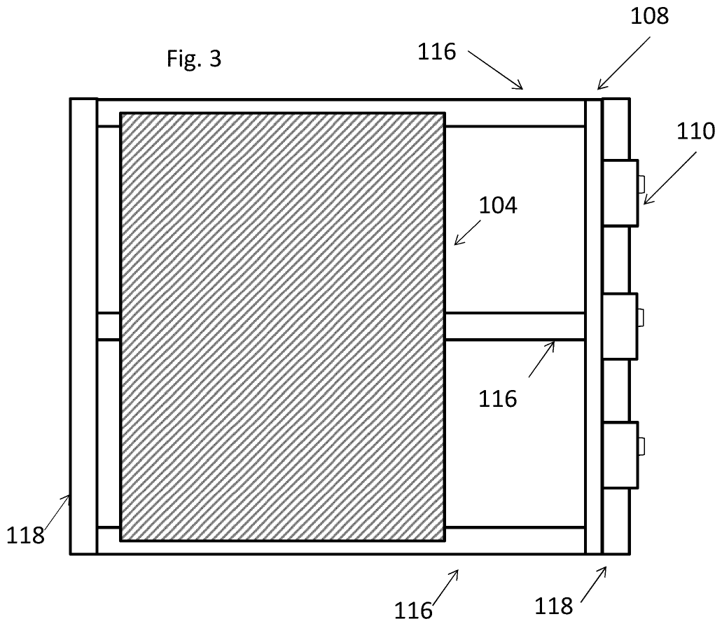

Referring now to FIGS. 1-4, an embodiment of an integrated transformer platform 100 is shown. Power supply platform 100 includes a base 102, a transformer 104 mounted on base 102, at least one panel board 106 with legs 108 mounted on base 102, and at least one disconnect 110 mounted on each panel board 106. Wire sets 114 (e.g., positive, negative, ground) run from each disconnect 110 through wire conduits 112 to an opening 120 in the bottom of transformer 102, where wire sets 114 enter transformer 104 from below and connect to internal components of transformer 104 as is known in the art.

Base 102 may have various features that provide various advantages. One feature is size and rigidity to support the transformer 104 (which may weigh several tons), light enough to allow for ease transport, and/or provide pathways by which wire sets 114 can run beneath transformer 102. A non-limiting example of base 102 is a lattice of interconnected aluminum I-beams, such as three lengthwise I-beams 116 as capped off by two widthwise I-beams 118 as shown in FIGS. 1-4, although other configurations may be used. The invention is not limited to the design of base 102.

Transformer 104 may be any transformer as is known in the art. Opening 120 in the bottom of transformer 104 allows the wire sets 114 to enter from below. This avoids openings in the top or sides of the shell that could provide a pathway for water or other environmental contaminants to enter transformer 104. Also any side or top of the transformer 104 can be made as a door without interference from wire sets 114. Connectors such as welds or flanges with bolts (not shown) may connect transformer 104 to base 102. The invention is not limited to the type of transformer 104 or the nature of the mounting of transformer 104 onto base 102.

Panel board 106 with legs 108 may be consistent with designs as known in the art. Panel board 106 may be any distance from transformer 102, and in particular 5-10 feet away. The base of legs 108 may be welded, bolted, or otherwise attached to base 102 by suitable means as known in the art. Only one panel board 106 is shown supporting three disconnects 110, but the invention is not limited to the number of panel boards or the number of disconnects per panel board. Panel board 106 is shown as positioned widthwise on the side of base 102, opposite transformer 104, and running almost the full width of the base 102. However, the invention is not so limited, and the panel board may have other lengths and be positioned at other locations or orientations on base 102.

Disconnects 110 may be consistent with disconnects as known in the art, may be mounted to panel boards 106 as is known in the art, and may be electrically connected to transformer 104 as is known in the art. The invention is not limited to the nature, location, or connections of disconnects 110.

Wire sets 114 may meet the local code requirements for use in a transformer/disconnect environment. Wire sets 114 may also be flexible enough to weave along the pathway between disconnect 110 and transformer 114 accounting for the shorter distances (e.g., 5-10 feet).

Wire sets 114 run from each disconnect 110 to transformer 104 along a wire pathway 112 through opening 120 in the bottom of transformer 104; two wire pathways from each disconnect 110 are shown for purposes of illustration, although the invention is not so limited and any number of wire pathways 112 as appropriate may be used. Each pathway 112 may have its own wire set, or wire sets may be combined into common wire pathways.

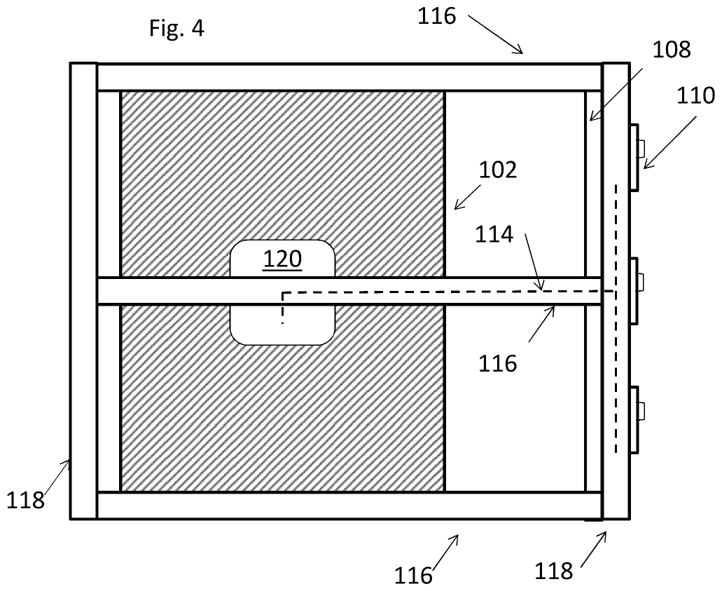

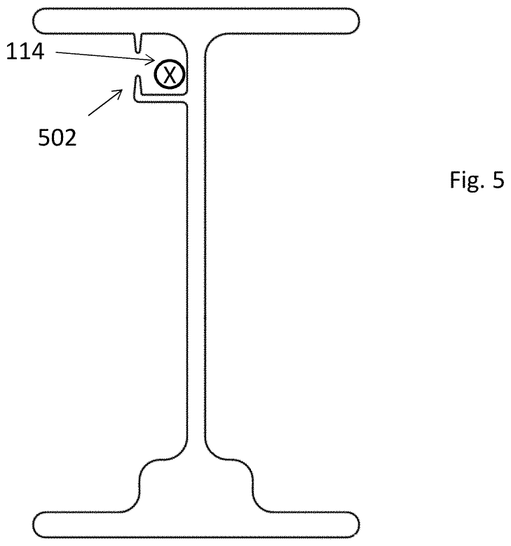

Wire pathway 112 may be at least partially defined by structural components in the platform 100 through which the wire sets 114 are fed. By way of piping such as SEAL TIGHT brand electrical conduit may extend from disconnects 110 down to base 102, and then laterally along the I-beams to opening 120. In another example, pathways in base 102 may form part of the wire pathways 112, such as by way of non-limiting a wire conduit 502 integral within the I-beams 116 or 118 as shown in FIG. 5. The pathways 112 may be independent from each other, or partially overlap such as in FIG. 4 (where wires extend individually from disconnects 110 to base 102, and then join at the center I-beam 116 where all three pathways 112 extend along that I-beam to opening 120). Panel board 106 and/or legs 108 could also have shapes that partially define wire pathway 112.

For installation, transformer 104 and panel board legs 108 are mounted on base 102, disconnects 108 are mounted on panel boards 106, any conduits that would at least partially define wire pathways 112 are connected, and wire sets 114 are laid along wire pathways 112 to connect disconnects 110 and transformers 104. The components may be assembled at a point of distribution and shipped as an integral component to a job site, installed entirely on the job site, or some combination thereof.

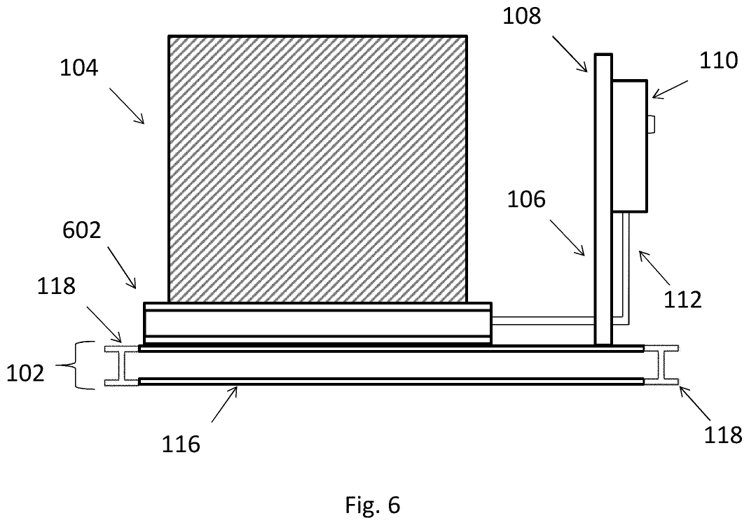

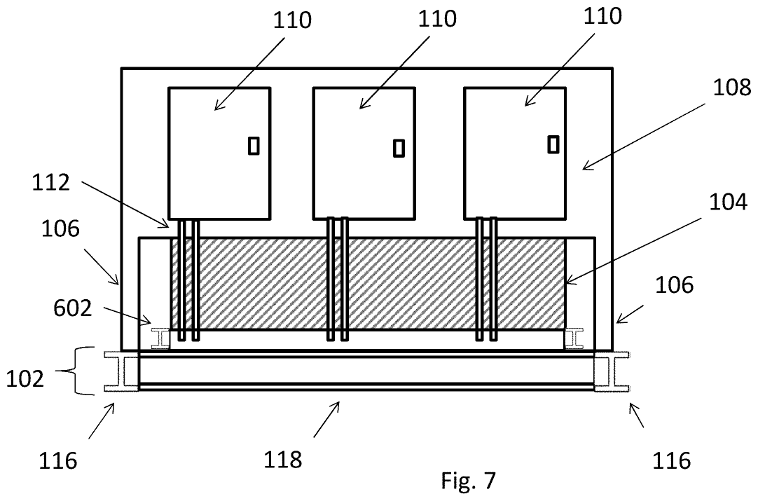

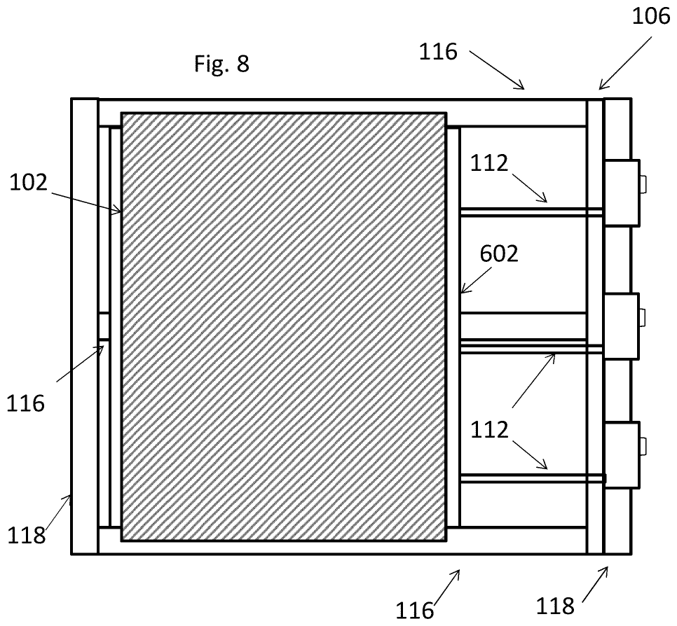

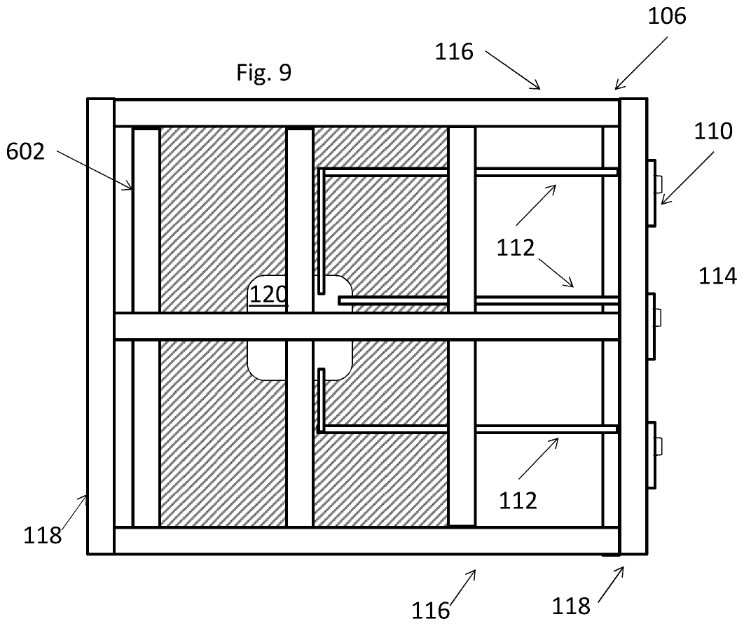

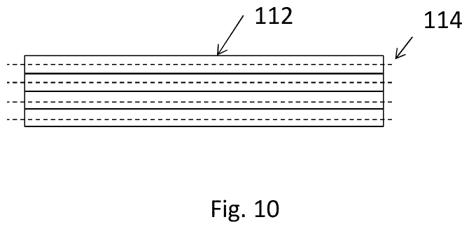

Referring now to FIGS. 6-9, another example of a platform 600 is shown. Platform 600 is similar to platform 100, and includes a second base 602 mounted on base 102 upon which transformer 104 is mounted; like base 102, second base 602 may be defined by interconnected I-beams such as shown in FIG. 5, although the invention is not so limited and base 602 may have other configurations. Wire pathways 112 are defined by conduits that extend from disconnects 110 and into a side of second base 602; conduits can extend into second base 602 to deliver wires to opening 120, and/or other pathways (e.g., wire conduit 502 in I-beams). Single conduits for all wire sets 114 or stacked conduits such as in FIG. 10 in which each wire set 114 traverses may also be used. Installation is the same as platform 100, save that second base 602 is mounted on base 102 and then transformer 104 is mounted on second base 602.

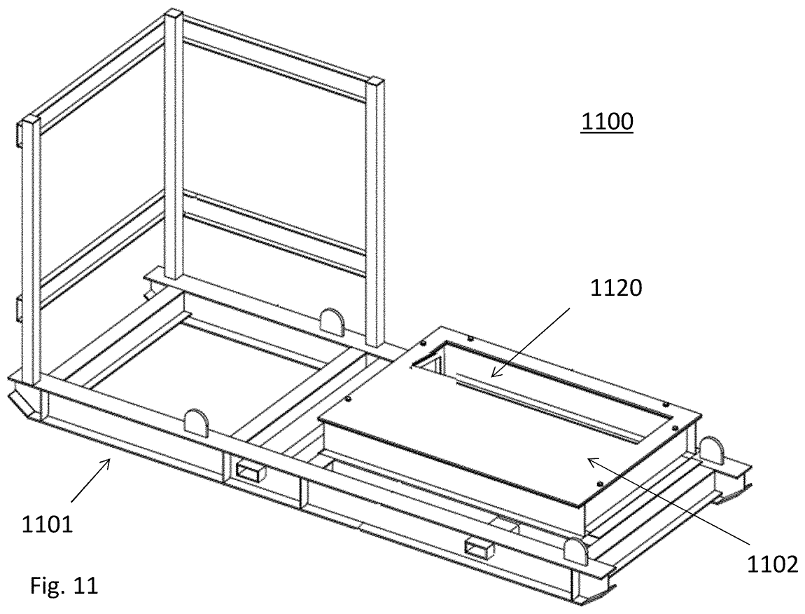

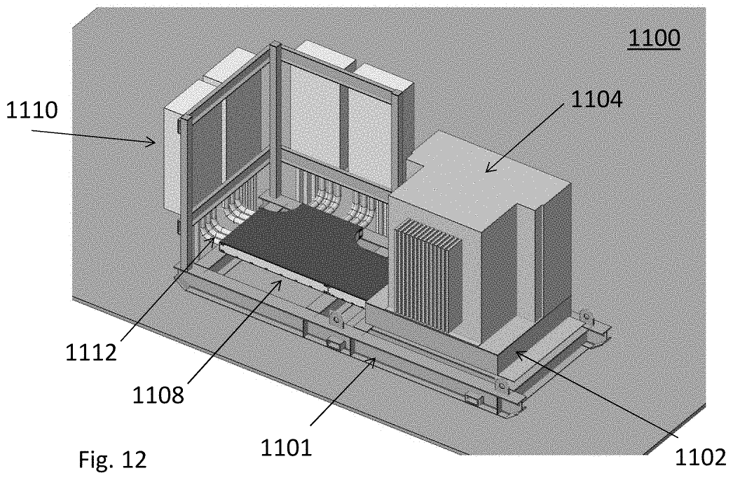

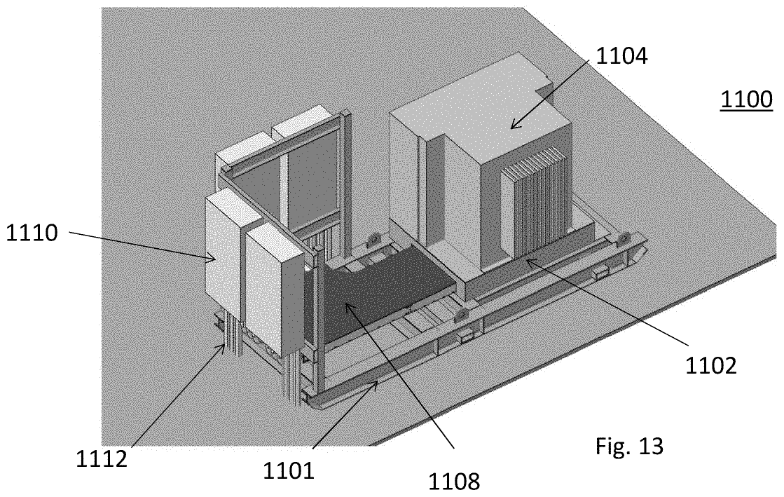

Referring now to FIGS. 11-13, another example of a platform 1100 is shown. Platform 1100, as shown in FIG. 11 without the electrical components and in FIGS. 12 and 13 with the electrical components, is similar to platform 600 and includes a second base 1102 mounted on base 1101 upon which transformer 1104 is mounted. Wire pathways 1112 are defined by a main conduits that extends from disconnects 1110, into a main conduit chamber 1108, into a side of second base 1102, and up through opening 1120. Installation is the same as platform 600.

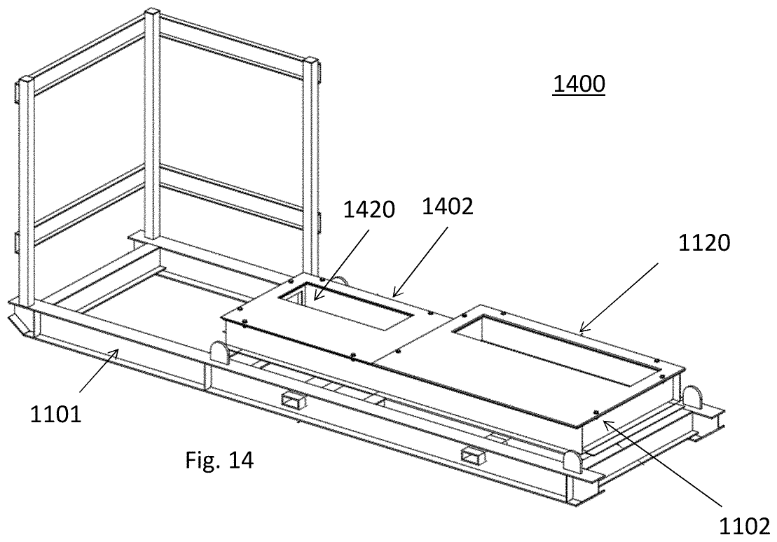

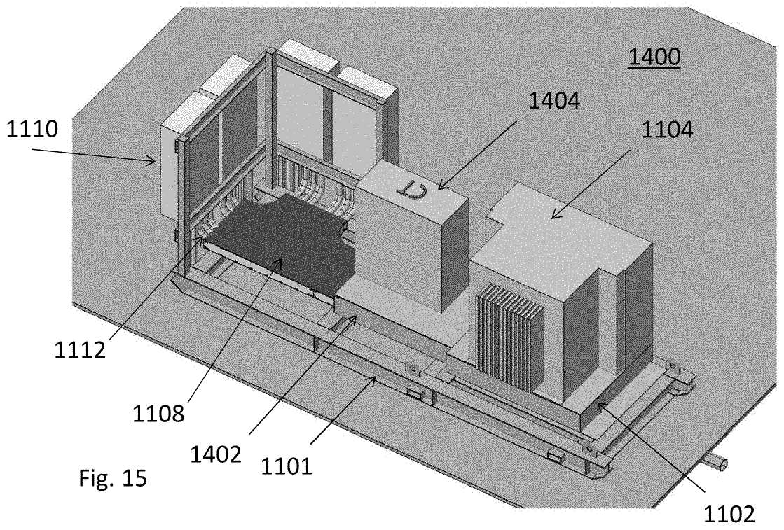

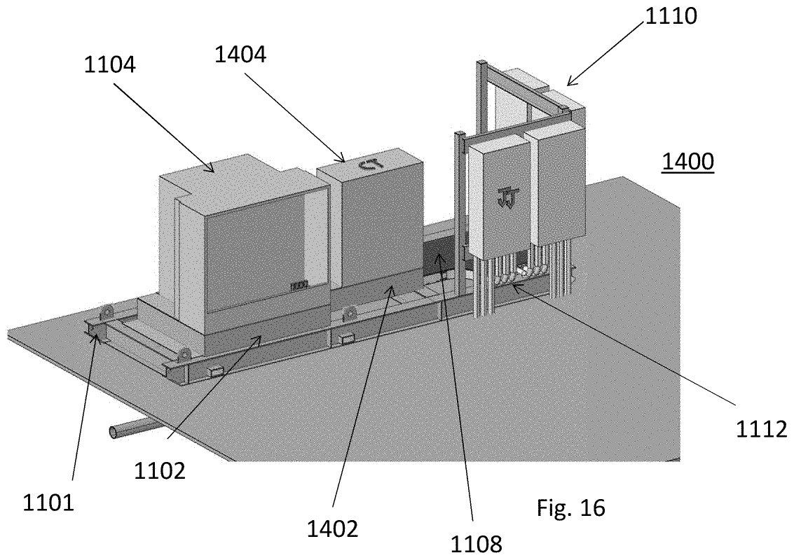

Referring now to FIGS. 14-16, another example of a platform 1400 is shown. Platform 1400, as shown in FIG. 14 without the electrical components and in FIGS. 15 and 16 with the electrical components, is similar to platform 1100 and additional includes a third base 1402 mounted on base 1101 upon which a third transformer 1404 is mounted. The wire pathways from the disconnects 1110 enter into the side of third base 1402 in the same manner as platform 1100. Those wires that are specific to the transformer 1404 will go up through opening 1420. Those wires that are specific to the transformer 1104 will continue through third base 1402 into the side of second base 1102 and go up through opening 1120. Installation is the same as platform 1100 as accounting for two transformers.

The above embodiments have various improvements over the prior art. No on site excavation is necessary for wires or panel boards. The components can be assembled indoors at points of distribution, which eliminates weather as a factor and the points of distribution may have dedicated lifting equipment for assembly that are not ordinarily found at the job site. MCHL cable is no longer needed, which alone eliminates some 40% of the materials costs of the prior art installation along with the labor savings from the lack of a need to dig a trench.

The specification and drawings are to be regarded in an illustrative rather than a restrictive sense. It will, however, be evident that various modifications and changes may be made thereunto without departing from the broader spirit and scope of the invention as set forth in the claims.

What is claimed is:

1. A power supply platform, comprising:
a first base;
a first transformer mounted above the first base and having an opening in a bottom side of the first transformer;
a panel board mounted on the first base;
a first disconnect mounted on the panel board;
a first wire set extending along a first wire pathway and connecting the first transformer and the first disconnect; and
the first wire pathway at least in part extending below the first transformer and entering the first transformer from the opening in the bottom side of the first transformer.

2. The platform of claim 1, where the first wire pathway extends through the first base.

3. The platform of claim 2, wherein the first base is at least partially defined by I-beams, and the first wire pathway extends at least partially along at least one of the I-beams.

4. The platform of claim 3, wherein the at least one of the I-beams has an wiring conduit and the first wire pathway extends along the wiring conduit.

5. The platform of claim 1, further comprising:
a second base mounted on the first base; and
the first transformer is mounted on the second base.

6. The platform of claim 5, further comprising the first wire pathway entering a lateral side of the second base and extending at least partially below the first transformer such that the first wire pathway comes from beneath the first transformer up through the opening in the bottom side of the first transformer.

7. The platform of claim 6, further comprising at least one conduit extending from the second base, the first wire pathway extending inside the conduit.

8. The platform of claim 7, wherein the at least one conduit is in parallel with the second base.

9. The platform of claim 1, further comprising:
a second transformer mounted above the first base and having an opening in a bottom side of the second transformer;
a second disconnect mounted on the panel board;
a second wire set extending along a second wire pathway and connecting the second transformer and the second disconnect; and
the second wire pathway at least in part extending below the first transformer and the second transformer, and entering the second transformer from the opening in the bottom side of the second transformer.
